(19) United States
(12) Patent Application Publication
(10) Pub. No.: US 2007/0007404 A1
(43) Pub. Date: Jan. 11, 2007

(54) Monitor stand

(75) Inventor: David M. Stravitz, New York, NY (US)

Correspondence Address: BRIAN ROFFE, ESQ, 11 SUNRISE PLAZA, SUITE 303, VALLEY STREAM, NY, 11580-6111, US

(73) Assignee: GREAT NOTIONS CORPORATION

(21) Appl. No.: 11/177,266

(22) Filed: Jul. 8, 2005

(51) Int. Cl. F16M 13/00

(52) U.S. Cl. 248/158

(57) ABSTRACT

Monitor stand for supporting a monitor includes a base having a monitor support section defining a substantially flat, upward facing surface adapted to support the monitor and at least one accessory support section, at least one monitor stand accessory, and a cooperating attachment arrangement arranged in connection with the base and each accessory for removably attaching each accessory to a respective accessory support section. The cooperating attachment arrangement may be a female connector arranged on each accessory section and a male connector arranged in connection with each accessory, or vice versa. Exemplifying, non-limiting types of accessories include a shelf accessory, a document holder accessory, a lamp assembly and a multi-section browser/sorter accessory.

### FIELD OF THE INVENTION

The present invention relates generally to monitor stands for supporting computer monitors and other display terminals and more particularly to monitor stands which can accommodate interchangeable and different accessories to aid in use of the computer, such as lights, shelves, document holders and multi-section browsers/sorters.

### BACKGROUND OF THE INVENTION

In desktop computer systems, monitor stands are often used to support a monitor above a flat surface on which a keyboard is placed, i.e., to elevate the monitor above the keyboard. Accessories such as speakers are typically placed alongside the monitor or attached to the monitor. Other accessories such as documents holders or clipboards are also often attached to the monitor and extend to a side of the monitor to enable documents to be placed thereon and easily viewed when viewing the monitor.

Relevant prior art which shows monitor stands which both support a monitor and enable placement, attachment or support of accessories, such as speakers, document holders or clipboards, in connection with the monitor or monitor stand include U.S. Pat. No. 5,385,327 (Hegarty et al.), U.S. Pat. No. 5,620,162 (Beckwith et al.), U.S. Pat. No. 5,683,070 (Seed), U.S. Pat. No. 5,738,320 (Matos et al.), U.S. Pat. Nos. 5,881,986 (Hegarty) and U.S. Pat. No. 5,988,582 (Olivo), and a monitor stand made by Kensington referred to as a Flat Panel SpaceSaver Station.

None of these prior art references provide a monitor stand which is capable of accommodating different combination of a plurality of different accessories, such as described below.

### OBJECTS AND SUMMARY OF THE INVENTION

It is an object of the present invention to provide new and improved monitor stands.

It is another object of the present invention to provide new and improved monitor stands which can accommodate a plurality of different accessories.

It is yet another object of the present invention to provide new and improved monitor stands which can interchangeably accommodate a variety of different accessories such that a particular accessory or combination of particular accessories can be used at one time and when it is desired to change one or more of the accessories, the change can be performed in a simple manner.

It is still another object of the present invention to provide new and improved monitor stands having shelves which can be rotated between different positions relative to a base of the monitor stand.

In order to achieve at least one of these objects and others, a monitor stand for supporting a monitor in accordance with the invention includes a base having a monitor support section defining a substantially flat, upward facing surface adapted to support the monitor and at least one accessory support section, at least one monitor stand accessory, and a cooperating attachment arrangement arranged in connection with the base and each accessory for removably attaching each accessory to a respective accessory support section. The cooperating attachment arrangement may be a female connector arranged on each accessory section and a male connector arranged in connection with or on each accessory, or vice versa.

Exemplifying, non-limiting types of accessories include a shelf accessory, a document holder accessory, a lamp assembly and a multi-section browser/sorter accessory. The shelf accessory has a shelf defining a horizontal support surface on which objects can be supported and has a projection arranged on its underside which defines a cavity receivable of a male connector member. The lamp accessory has a flexible vertical support member, a light unit arranged at an upper end portion thereof and a cord connected to the light unit and extending through the support member. A male connector part is arranged at a lower end portion of the support member. The document holder accessory has a flexible vertical support member and a clipboard unit arranged at an upper end portion thereof. A male connector part is arranged at a lower end portion of the support member. The clipboard unit includes a board having a substantially flat surface and a spring-biased clip which is biased into contact with the flat surface of the board. The multi-section browser/sorter accessory has a shaft and a browser/sorter arranged at an upper end portion of the shaft. A male connector part is arranged at a lower end portion of the shaft. The browser/sorter includes a base and a plurality of rotatable dividers arranged in connection with the base to define an object-retaining section between adjacent dividers.

One or more drawers may be provided on the monitor stand and each slides into a respective recess formed in a front wall of the base and opening thereto. Below the drawers, a recess is provided which can accommodate the keyboard in a position at least partially below the monitor support section.

Although various and different combinations of the accessories can be provided in a monitor stand in accordance with the invention which includes two accessory support sections, in one particular group of embodiments, one of the accessories is a lamp accessory, a document holder accessory or a multi-section browser/sorter accessory (as described above). The other accessory can be one of these or a shelf accessory as described above.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a front perspective view of a monitor stand in accordance with the invention.

FIG. 2 is a front view of the monitor stand shown in FIG. 1.

FIG. 3 is a right side view of the monitor stand shown in FIG. 1.

FIG. 4 is an exploded view of the monitor stand shown in FIG. 1 having a single shelf.

FIG. 5 is a top view of part of the monitor stand shown in FIG. 1 showing a centered position of a shelf.

FIG. 6 is a top view of part of the monitor stand shown in FIG. 1 showing an outward position of a shelf and alternative positions.

FIG. 7 is a front perspective view of a monitor stand in accordance with the invention with a different set of accessories than shown in FIG. 1.

FIG. 8 is a front perspective view of a monitor stand in accordance with the invention with a different set of accessories than shown in FIGS. 1 and 7.

### DETAILED DESCRIPTION OF THE INVENTION

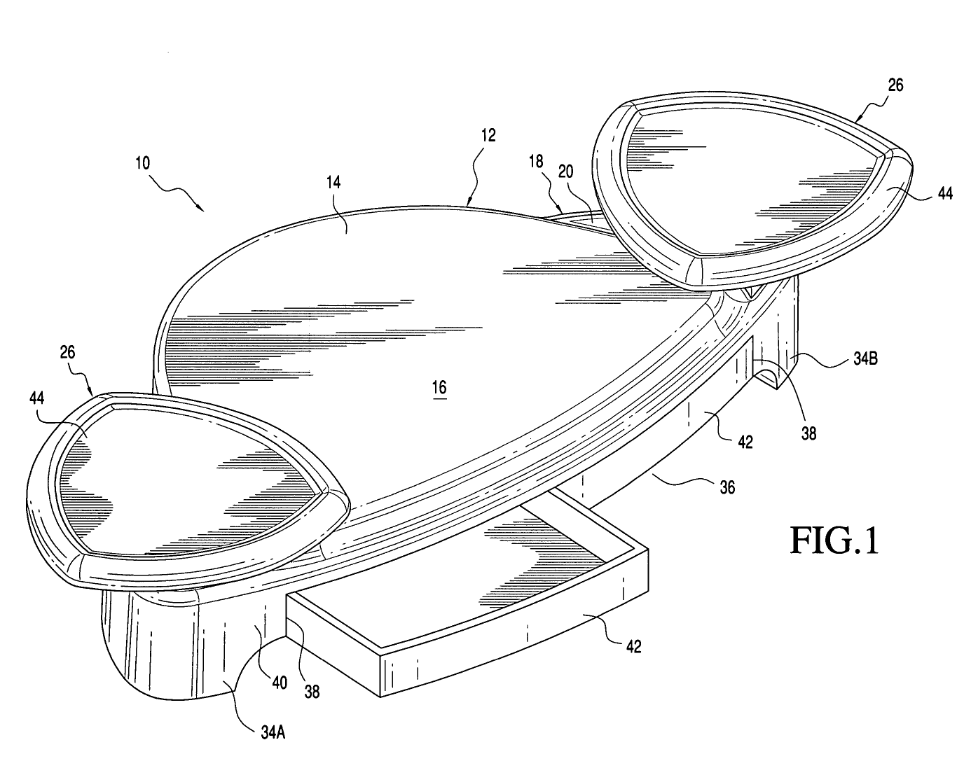

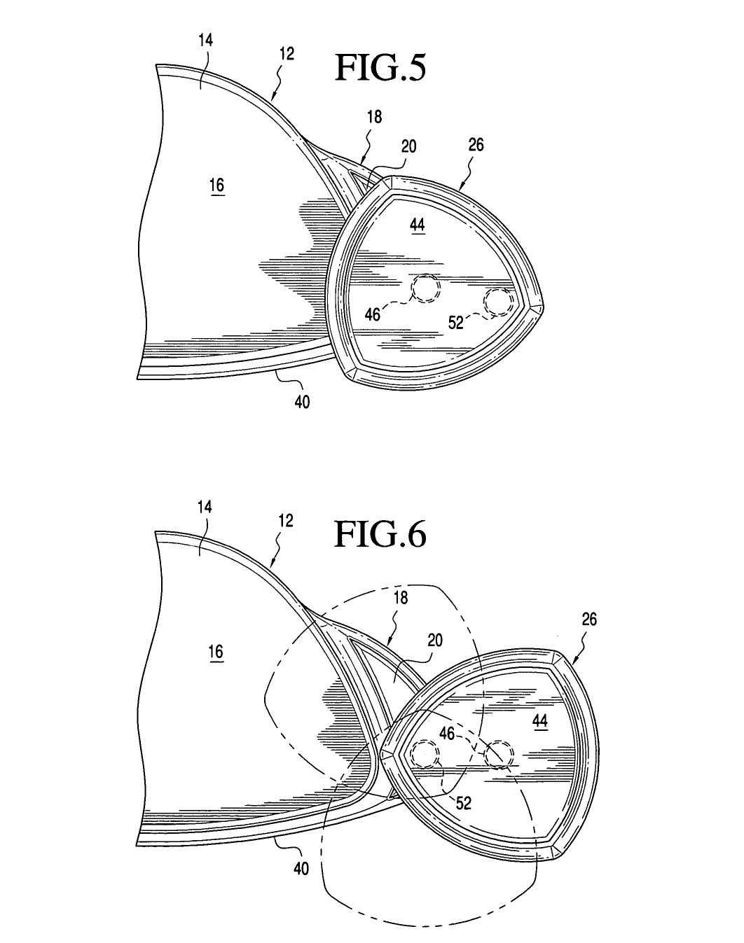

Referring to FIGS. 1-6, a monitor stand in accordance with the invention is designated generally as 10 and comprises a base 12 having a monitor support section 14 defining a substantially flat, upward facing surface 16 and accessory support sections 18, one on each side of the monitor support section 14. Each accessory support section 18 includes a substantially flat upward facing surface 20 and a female connector 22 which is designed to engage with a male connector member 24 arranged in connection with one of a plurality of different accessories 26, 28, 30, 32 which may be used as part of the monitor stand 10. Upward facing surfaces 20 of the accessory support sections 1 8 are situated at a different elevation than the upward facing surface 16 of the monitor support section 14, i.e., a lower elevation.

Monitor support section 14 is preferably dimensioned to be large enough to support a variety of monitor bases, e.g., bases for 15 inch monitors, bases for 17 inch monitor and bases for 19 inch monitor, and for both traditional and flat panel types. The size of such bases would be determined and then the monitor support section 14 could be dimensioned accordingly.

As shown in FIG. 1, base 12 has a generally triangular shape with curved sides and corners. The monitor support section 14 extends to the rear corner of the base 12 while the accessory support sections 18 are situated at the other two corners of the base 12, with the female connectors 22 thereof arranged or formed at or proximate these corners. This construction is not limiting and the base 12 can have other shapes and the number and location of the accessory support sections 18 and female connectors 22 arranged or formed thereon can vary. For example, a monitor stand in accordance with the invention can be provided with a single accessory support section on one side of the monitor support section and can include one or a plurality of female connectors.

Base 12 is constructed with support legs 34A, 34B, 34C, one at each corner, which elevate the monitor support section 14 above a horizontal surface on which the monitor stand 10 rests. Support legs 34A, 34B and 34C may include raised beads as rubber feet to cushion the horizontal surface on which the monitor stand 10 is placed.

A recess 36 is formed between support legs 34A and 34B which is dimensioned to allow a keyboard to be passed into and at least partially through it in order to be stored at least partially under the monitor support section 14. An exemplary width of recess 36 is about 19.5 inches. Depending on the size of the base 12, a recess may also need to be formed between support legs 34A and 34C and another recess between support legs 34B and 34C to enable the keyboard to be situated below the monitor support section 14.

Base 12 is provided with a pair of recesses 38 opening to a front wall 40 and drawers 42 are slidable in the recesses 38. Base 12 and drawers 42 may be designed so that outward sliding movement of the drawers 42 is limited in order to retain the drawers 42 in engagement with the base 12 (a mechanism to limit outward movement of a drawer being known to those skilled in the art). Base 12 and drawers 42 may be formed of plastic and in the same color.

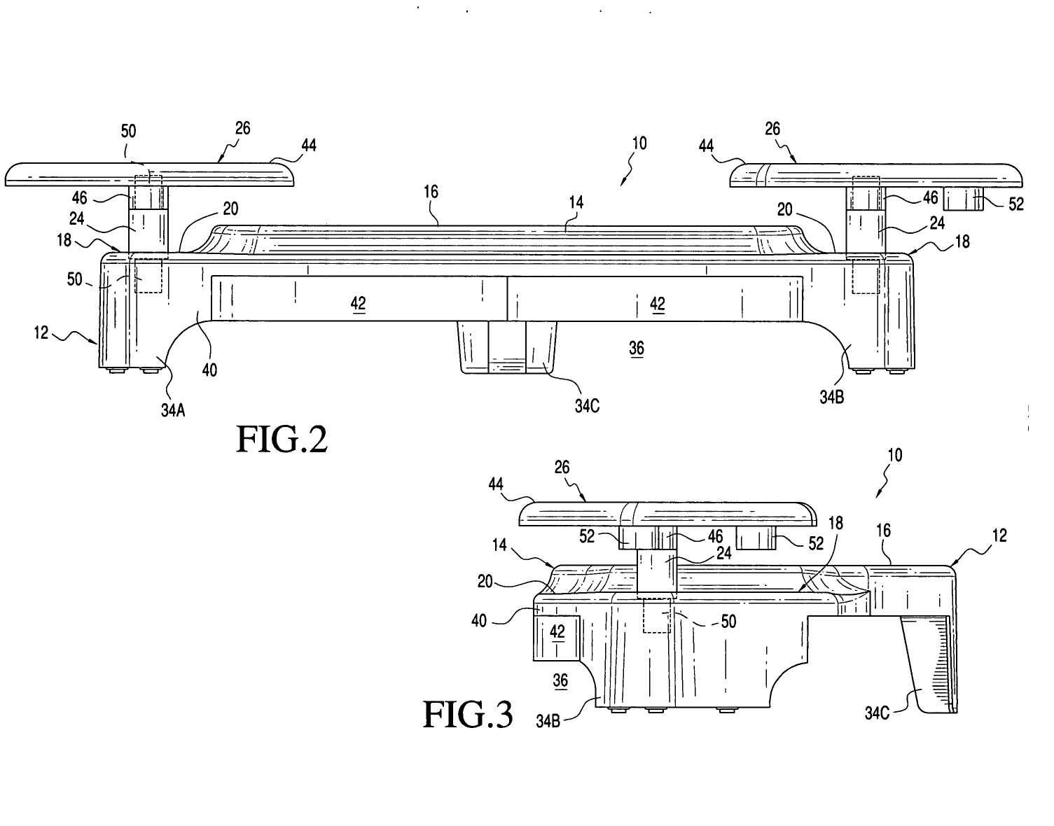

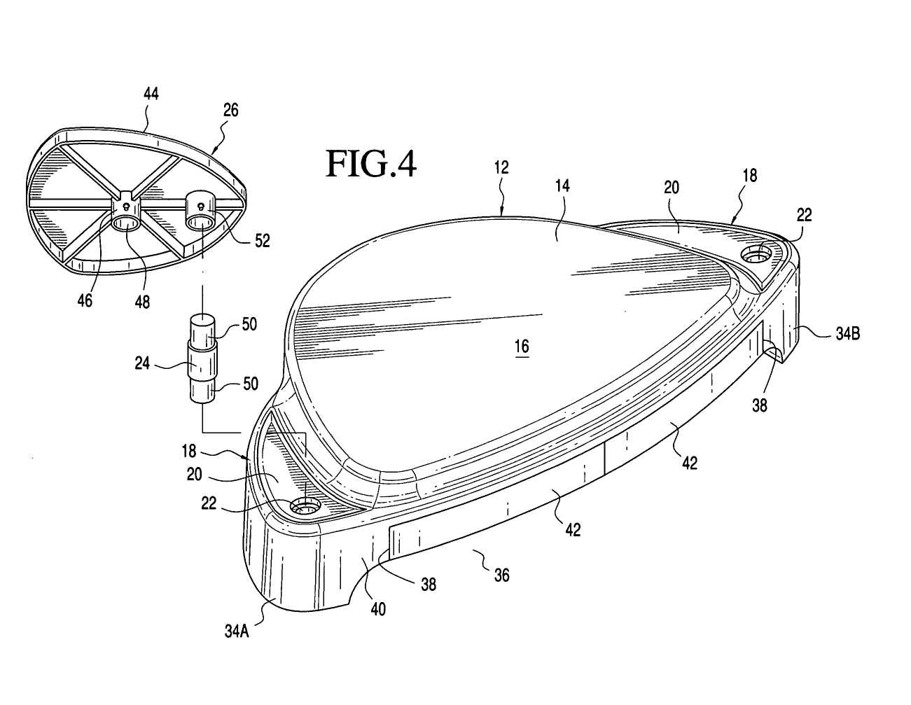

As shown in FIGS. 1 and 2, monitor stand 10 includes a pair of shelf accessories 26, each of which has a shelf 44 defining a substantially horizontal upper surface capable of supporting objects. Each shelf accessory 26 also includes a projection 46 on a lower surface of the shelf 44 defining a cavity 48 which receives one end of the male connector member 24, the other end of which is received by the female connector 22 on a respective accessory support section 18 (see FIG. 4). Alternative connecting arrangements for connecting the shelf 44 to the female connector 22 are also possible. For example, a male connector can be formed directly on and/or integral with the shelf 44. Exemplifying objects which a user might want to use the shelf accessory 26 to support include computer peripherals such as speakers, food-related objects such as coffee mugs, water bottles, lunch containers and the like and miscellaneous objects desired by the computer user to be in close proximity to the computer to aid in use thereof, such as paper pads and self-adhesive note pads.

Shelf accessory 26 may be made entirely of plastic and provided with a stiffening or strength form, e.g., ribs on the underside of the shelf 44, to ensure it has sufficient strength to retain objects commonly used or contemplated for use during computer use, such as those mentioned above.

Male connector member 24 is designed to provide secure attachment of the shelf accessory 26 to the female connector 22 and to this end, is preferably provided with nubs 50 at its ends which frictionally engage the inner surfaces of the projection 46 defining cavity 48 and the female connector 22. In this manner, a secure attachment is provided which enables the shelf accessory 26 to securely maintain objects thereon while allowing detachment of the shelf accessory 26 from the base 12 when an alternative accessory is desired for use (such alternative accessories being discussed below). Nubs 50, female connector 22 and the cavity 48 in the projection 46 can be provided with spiral threads if a threaded engagement of the male connector member 24 to the shelf accessory 26 and base 12 are desired. In this case, by rotating the accessory 26 in one direction relative to the base 12, the accessory 26 is engaged with the base 12 while rotation of the accessory 26 in the opposite direction enables disengagement of the accessory 26 from the base 12. Other mechanisms to enable a removable attachment of the accessory 26 to the base 12 are also envisioned within the scope and spirit of the invention.

As shown in FIG. 4, projection 46 is centered. However, shelf accessory 26 may also be provided with an off-centered projection 52 defining a cavity receivable of nub 50 of the male connector member 24 in a similar manner as cavity 48 defined by projection 46. When off-centered projection 52 is used to connect the shelf accessory 26 to the base 12, the shelf accessory 26 can be swiveled to different positions relative to the monitor support section 14 (see FIG. 6 wherein one position is shown in solid lines and two alternative positions are shown in phantom). Thus, the shelf accessory 26 can be rotated out of the way of the monitor if it interferes with viewing of the monitor when situated on the monitor support section 14. Moreover, the shelf accessory 26 can be rotated to whatever position is best suited for the user, i.e., if a cup of coffee is being supported on the shelf 44, the user can rotate the shelf accessory 26 until it is optimally placed to enable easy grabbing of the coffee cup.

To place shelf accessory 26 into connection with the base 12, the user inserts one end of the male connector member 24 into the cavity defined by one of the projections 46, 52 on the underside of the shelf 44 and engages the other end of the male connector member 24 with the female connector 22 in the base 12. Removal of the shelf accessory 26 from engagement with the base 12 requires pulling the shelf 44 upward.

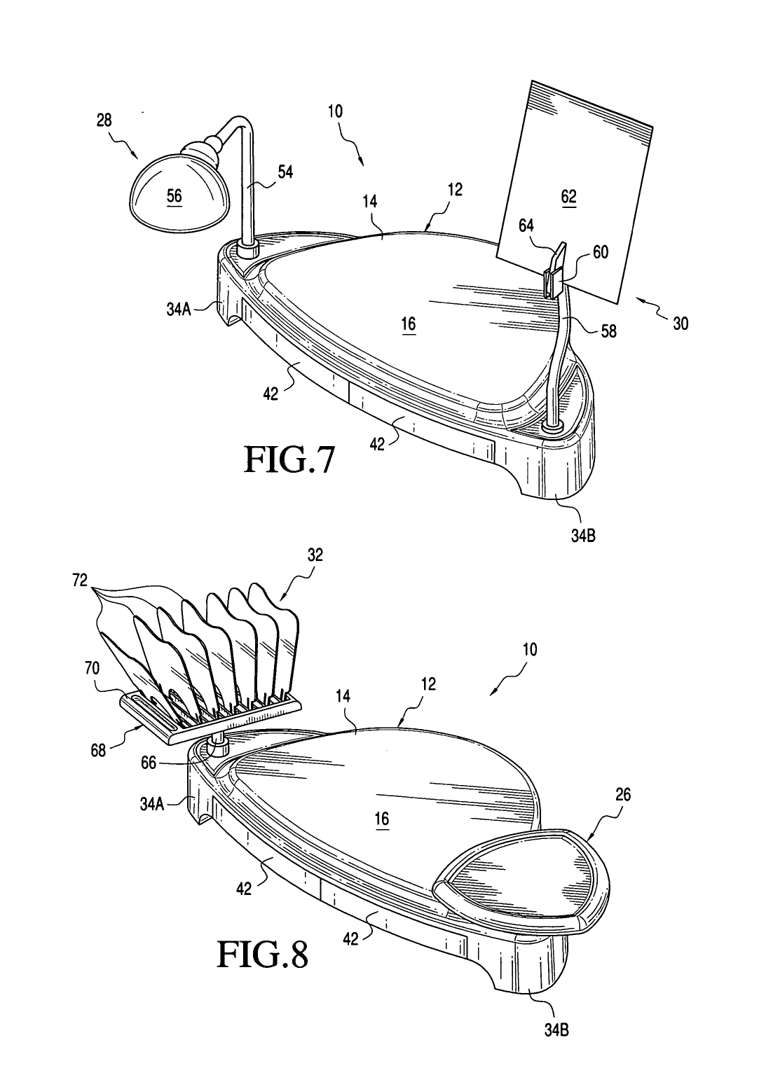

Referring now to FIGS. 7 and 8, monitor stand 10 can be used with different sets of accessories. FIG. 1 shows the use of a pair of shelf accessories 26. FIG. 7 shows the use of a lamp accessory 28 and a document holder accessory 30. FIG. 8 shows the use of a multi-section browser/sorter accessory 32 and a shelf accessory 26. Different combinations of these accessories and use of two of the same type of accessory are also envisioned to be within the scope and spirit of the invention, FIG. 7 shows a lamp accessory 28, in the form of a goose-neck lamp, which includes a flexible vertical support member 54 having a nub arranged at a lower end section, and a light unit 56 arranged at an upper end section of the support member 54. Light unit 56 includes conventional electrical hardware for receiving a light bulb, i.e., a socket, for conveying electricity thereto and for turning the light bulb on and off, e.g., a switch. A cord (not shown) connects to the electrical hardware in light unit 56 and extends through the support member 54 for connection to a power outlet. Instead of a nub at the lower end of the vertical support member 54, another male connector part can be used.

To use lamp accessory 28, the user threads the cord through an opening in a female connector 22 in the base and then pulls the cord from below the base 12. The nub is then engaged with the female connector 22 in the base 12 and secured in position. The cord is plugged into an outlet and by activating the switch, the light bulb is turned on and off. By virtue of the flexibility of the support member 54, the position of the light unit 56 can be moved to a desired position, and away from a monitor supported on the monitor support section 14 if necessary or desired. Removal of the lamp accessory 28 from engagement with the base 12 requires removing the plug from the outlet and threading it back through the opening in the female connector 22, and disengaging the male connector member 24 from the female connector 22.

FIG. 7 also shows a document holder accessory 30, in the form of a goose-neck clip board, which includes a flexible vertical support member 58 having a nub arranged at a lower end section, and a clipboard unit 60 arranged at an upper end section of the support member 58. Clipboard unit 60 includes a board 62 having a substantially flat surface and a spring-biased clip 64 which is biased into contact with the flat surface of the board 62. Although the clip 64 is shown at a bottom of the board 62, it can alternatively be placed at the top of the board 62 or at any other position along the board 62.

To use document holder accessory 30, the user engages the nub with the female connector 22 in the base 12 and secures it in a position in which the flat surface of the board 62 is positioned in a desired orientation relative to the user. By virtue of the flexibility of the support member 58, the position of the clipboard unit 60 can also be moved to a desired position, and away from a monitor supported on the monitor support section 14 if necessary. A document can be retained by document holder accessory 30 by separating the clip 64 from contact with the board 62, placing a document against the board 62 such that a portion thereof is between the board 62 and the clip 64 and then releasing the clip 64 to cause it to press the document against the board 62.

FIG. 8 shows a multi-section browser/sorter accessory 32 in accordance with the invention which includes a rigid vertical support member or shaft 66 having a nub at the bottom, and a browser/sorter 68 arranged at the top of the shaft 66. Browser/sorter 68 includes a base 70 and a plurality of dividers 72 arranged in connection with the base 70 to define an object-retaining section between adjacent dividers 72. Dividers 72 can be rotated, i.e., flipped back and forth, in the same manner as conventional browser/sorters.

To use browser/sorter accessory 32, the user engages the nub with the female connector 22 in the base 12 and secures it in a position in which the dividers 72 are positioned in a desired orientation relative to the user. Documents or file folders are then freely insertable into and removable from the object-retaining sections.

For the lamp accessory 28, document holder accessory 30 and multi-section browser/sorter accessory 32, each accessory includes a support member having a nub or other male connector part at the bottom. Alternatively, a separate male connector member can be provided which removably connects to the support member of each accessory.

A kit including the monitor stand 10 in accordance with the invention would include the base 12 and a plurality of accessories, including one or more of each of accessories 26, 28, 30, 32. The user can decided which accessories 26, 28, 30, 32 to use each time they use the computer and change the accessories during a single use of the computer.

Variations in the construction of the base 12 and accessories 26, 28, 30, 32 are possible. For example, base 12 can includes a channel connecting the accessory support sections 18 in front of the monitor support section 14 to enable writing utensils and the like to be stored on the monitor stand 10.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

I claim:

1. A monitor stand for supporting a monitor, comprising:
a base having a monitor support section defining a substantially flat, upward facing surface adapted to support the monitor and at least one accessory support section;
at least one monitor stand accessory; and
cooperating attachment means arranged in connection with said base and said at least one accessory for removably attaching each of said at least one accessory to a respective one of said at least one accessory support section of said base.

2. The monitor stand of claim 1, wherein said at least one accessory support section comprises two accessory support sections, one on each side of said monitor support section.

3. The monitor stand of claim 1, wherein said cooperating attachment means comprise a female connector arranged on each of said at least one accessory section and a male connector member arranged in connection with each of said at least one accessory.

4. The monitor stand of claim 3, wherein said at least one accessory includes a shelf accessory having a shelf defining a horizontal support surface on which objects can be supported and at least one projection arranged on an underside of said shelf and defining a cavity, said male connector member being insertable into said cavity of a respective one of said at least one projection.

5. The monitor stand of claim 4, wherein said at least one projection comprises a first projection centered on the underside of said shelf and a second projection arranged off-center on the underside of said shelf.

6. The monitor stand of claim 1, wherein said cooperating attachment means comprise a female connector arranged on each of said at least one accessory section and a male connector part formed on each of said at least one accessory.

7. The monitor stand of claim 6, wherein said at least one accessory includes a lamp accessory having a flexible vertical support member, a light unit arranged at an upper end portion of said support member and a cord connected to said light unit and extending through said support member, said male connector part being formed at a lower end portion of said support member.

8. The monitor stand of claim 6, wherein said at least one accessory includes a document holder accessory having a flexible vertical support member and a clipboard unit arranged at an upper end portion of said support member, said male connector part being arranged at a lower end portion of said support member, said clipboard unit including a board having a substantially flat surface and a spring-biased clip which is biased into contact with said flat surface of said board.

9. The monitor stand of claim 6, wherein said at least one accessory includes a multi-section browser/sorter accessory having a shaft and a browser/sorter arranged at an upper end portion of said shaft, said male connector part being arranged at a lower end portion of said shaft, said browser/sorter including a base and a plurality of rotatable dividers arranged in connection with said base to define an object-retaining section between adjacent ones of said dividers.

10. The monitor stand of claim 1, wherein said base includes a front wall, at least one recess opening to said front wall and at least one drawer slidable in a respective one of said recesses.

11. The monitor stand of claim 9, wherein said at least one drawer consists of a pair of drawers arranged alongside one another.

12. The monitor stand of claim 1, wherein said at least one accessory is selected from a group consisting of a lamp accessory, a document holder accessory and a multi-section browser/sorter accessory.

13. A monitor stand for supporting a monitor and having a plurality of different configurations, comprising:
a base having a monitor support section defining a substantially flat, upward facing surface adapted to support the monitor and first and second accessory support sections;
first and second monitor stand accessories, said first accessory being selected from a group consisting of a lamp accessory, a document holder accessory and a multi-section browser/sorter accessory; and
cooperating attachment means arranged in connection with said base and said first and second accessories for removably attaching each of said first and second accessories to a respective one of said first and second accessory support sections of said base.

14. The monitor stand of claim 13, wherein said first and second accessory support sections are arranged one on each side of said monitor support section.

15. The monitor stand of claim 13, wherein said cooperating attachment means comprise a female connector arranged on each of said first and second accessory support sections and a male connector member arranged in connection with each of said first and second accessories.

16. The monitor stand of claim 15, wherein said second accessory is a shelf accessory having a shelf defining a horizontal support surface on which objects can be supported and at least one projection arranged on an underside of said shelf and defining a cavity, said male connector member being insertable into said cavity of a respective one of said at least one projection.

17. The monitor stand of claim 13, wherein said cooperating attachment means comprise a female connector arranged on each of said first and second accessory sections and a male connector part formed on each of said first and second accessories.

18. The monitor stand of claim 17, wherein said first accessory is a lamp accessory having a flexible vertical support member, a light unit arranged at an upper end portion of said support member and a cord connected to said light unit and extending through said support member, said male connector part being arranged at a lower end portion of said support member.

19. The monitor stand of claim 13, wherein said first accessory is a document holder accessory having a flexible vertical support member and a clipboard unit arranged at an upper end portion of said support member, said male connector part being arranged at a lower end portion of said support member, said clipboard unit including a board having a substantially flat surface and a spring-biased clip which is biased into contact with said flat surface of said board.

20. The monitor stand of claim 13, wherein said first accessory is a multi-section browser/sorter accessory having a shaft and a browser/sorter arranged at an upper end portion of said shaft, said male connector part being arranged at a lower end portion of said shaft, said browser/sorter including a base and a plurality of rotatable dividers arranged in connection with said base to define an object-retaining section between adjacent ones of said dividers.
